(19) United States
(12) Patent Application Publication
(10) Pub. No.: US 2007/0189494 A1
(43) Pub. Date: Aug. 16, 2007

(54) Methods and apparatus for estimating call intents and recalls

(76) Inventors: Fabrice Chauvet, Chatenay-Malabry (FR); Rabie M. Nail-Abdallah, Boulogme-Billancount (FR); Benedicte Vatinlen, Boulogne-Billantcount (FR); Alexandre Meyrignac, Paris (FR)

Correspondence Address: IP GROUP OF DLA PIPER US LLP, ONE LIBERTY PLACE, 1650 MARKET ST, SUITE 4900, PHILADELPHIA, PA, 19103, US

(21) Appl. No.: 10/591,982

(22) PCT Filed: Mar. 8, 2005
(86) PCT No.: PCT/FR05/00555

§ 371 Date: Oct. 10, 2006

(30) Foreign Application Priority Data
Mar. 8, 2004 (FR) 0450462

(51) Int. Cl. H04M 3/00; H04M 5/00

(52) U.S. Cl. 379/265.02

(57) ABSTRACT

A method of estimating call intents and recalls in a call center including (a) assessing N corresponding to a number of periods during which recall assessments are performed; (b) assessing αᵢ representing a proportion of disconnected calls that call back during an i^{th} period following disconnection; (c) assessing βᵢ representing a proportion of abandoned calls that call back during an i^{th} period following abandonment; (d) assessing call status variables: Dec(p) representing the number of calls disconnected during a period p; Abd(p) representing the number of calls abandoned during a period p; Reçus(p) representing the number of calls received during period p; (e) estimating the number of recalls, rappels(p), during the period p, with

$$rappels ( p ) = {\sum }_{i = 0}^{N} {α}_{i} \cdot dec ( p - i ) + {β}_{i} \cdot abd ( p - i ) ,$$

where p-i represents the period that precedes p of i periods; and (f) assessing the number of call intents during a period p, intentions(p)=reçus(p)−rappels(p).

### RELATED APPLICATION

This is a §371 of International Application No. PCT/FR2005/000555, with an international filing date of Mar. 8, 2005 (WO 2005/088950, published Sep. 22, 2005), which is based on French Patent Application No. 04/50462, filed Mar. 8, 2004.

### TECHNICAL FIELD

This disclosure relates to the field of queues, more specifically, to estimating call intents and recalls in a call center.

### BACKGROUND

Queue-based systems can be found in many business sectors. These consist, in general terms, of a system comprising one or several operators with the purpose of replying to customers that arrive in a random fashion. If, upon the arrival of a customer, no operators are available, the customer must wait in a queue before the call can be answered. There are many examples in various fields of activity that illustrate this type of system. Examples include vehicles waiting to pay a toll on a motorway, data packages waiting to be processed in a computer network, or customers calling a call center and waiting for a customer service representative to answer them.

U.S. Pat. No. 5,905,793 discloses a method for selecting calls on hold based on their anticipated waiting times. The maximum waiting time for callers to a call center is reduced by selecting, for a representative that has just become available to answer a call, a high-priority call on hold, which will have to wait longer than any other call on hold if it is not answered at that moment. Anticipated waiting times are calculated for the calls at the top of the non-empty queues of high-priority calls that match the skills of the representative. The anticipated waiting time of a call is calculated as being the current waiting time (elapsed) of the call plus the average progress rate for the calls in the call queue. The call with the longest anticipated waiting time is then chosen first and transferred to the available representative to be processed. The process is repeated every time a representative becomes available.

WO 01/63894 discloses a system and method that makes it possible to predict the waiting time for a caller to a call center. The call center defines a group of representatives for whom the caller may be placed in the queue. The choice of this group of representatives may depend on the specific skills of each representative, the type of service required by the customer, the priority of the caller, the time, the day of the week or any other conditions. An initial estimate of the waiting time can then be sent to the caller who was just placed in the queue. Given that the conditions of a caller can change dynamically, the position of a caller in the queue can also change, as can the group of available representatives. Periodic updates of the estimated waiting time can also be sent to the caller waiting in the queue. The waiting time for a caller can be calculated according to the average intervals that separate the arrival of recent calls to the call center. An average time between arrivals can be calculated for the last several calls.

In another embodiment, the waiting time for a caller can be calculated according to the calls placed in the queue and leaving the queue recently. A table of values, Wnj, is kept, in which each value indicates the j^{th} recent waiting time of calls arriving after n calls are already placed in the queue. This makes it possible to calculate an average value, Wn, for each n among all the Wnj and to provide the caller with an estimated waiting time, according to the number of calls already in the queue at the time of the call.

US 2001/0000458 discloses a method of calculating the waiting time in a queue system for telephone routing. This method has the advantage of taking priorities among customers into consideration. That method requires a very large number of real-time measurements and information on the status of the system. It is, for example, necessary to know the actual number of representatives that are answering calls. This requires the use of further equipment (CIT or Computer Integrated Telephony) in addition to the ACD (Automatic Call Dispatcher). The routing takes place in the ACD alone and only a limited amount of information is known in real time.

Thus, the prior art does not address the problem of estimating the number of call intents, and merely assesses waiting times.

### SUMMARY

This invention relates to a method of estimating call intents and recalls in a call center including (a) assessing N corresponding to a number of periods during which recall assessments are performed; (b) assessing αi representing a proportion of disconnected calls that call back during an ith period following disconnection; (c) assessing βi representing a proportion of abandoned calls that call back during an ith period following abandonment; (d) assessing call status variables: Dec(p) representing the number of calls disconnected during a period p; Abd(p) representing the number of calls abandoned during a period p; and Reçus(p) representing the number of calls received during period p; (e) estimating the number of recalls, rappels(p), during the period p, with Error! Objects cannot be created from editing field codes, where p-i represents a period that precedes p of i periods; and (f) assessing the number of call intents during a period p, intentions(p)=reçus(p)−rappels(p).

This invention also relates to a system for estimating call intents and recalls in a call center including calculation equipment connected to equipment associated with call-answering stations, wherein the calculation equipment includes means for counting a number of disconnected calls Dec, a number of abandoned calls Abd, a number of received calls Reçus and calculation means for determining coefficients αᵢ, βᵢ and N, as well as calculation means for determining variables of the number of recalls and the number of call intents

$$rappels ( p ) = {\sum }_{i = 0}^{N} {α}_{i} \cdot dec ( p - i ) + {β}_{i} \cdot abd ( p - i )$$

and intentions(p)=reçus(p)−rappels(p), where N corresponds to a number of periods during which an assessment of recalls takes place; αᵢ represents a proportion of disconnected calls that call back during an i^{th} period following disconnection; βᵢ represents a proportionof abandoned calls that call back during an i^{th} period following abandonment; and p-i represents a period that precedes p of i periods.

### BRIEF DESCRIPTION OF THE DRAWINGS

The disclosure will be better understood from reading the following description, provided below by way of example made in reference to the appended figures, in which:

FIG. 1 shows the general principle of a call to the call center; and

FIG. 2 is a flowchart of the process of calling and of recalls for disconnections and abandonments.

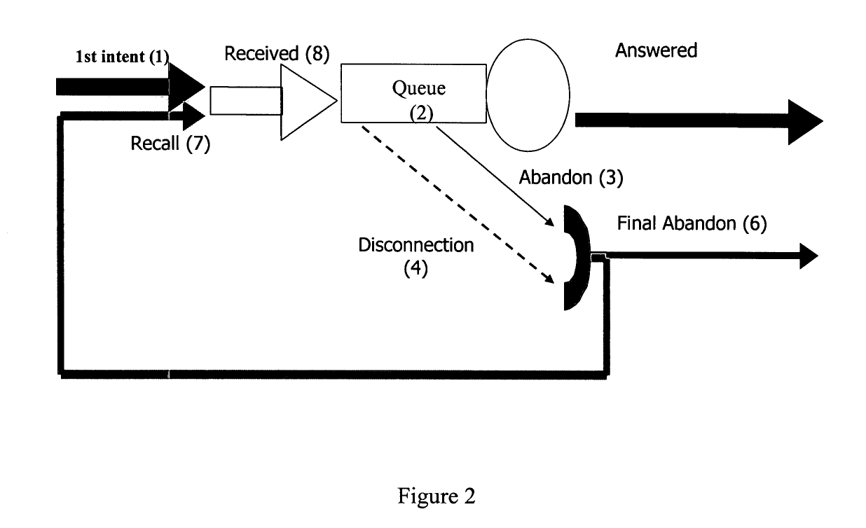

### DETAILED DESCRIPTION

Beyond management of waiting times in accordance with the prior art, we employ a direct assessment of the number of call intents and recalls to enable particularly efficient management of the call center.

To do so, an evident method for assessing the number of call intents or of recalls in a given period may be to systematically list the identifier of each call received (for example, the telephone number). In this way, it is possible to determine, when a call arrives, whether it is a first call intent or a recall. If the call identifier is already listed and has not yet been answered then it is a recall. Otherwise, it is a first call intent.

However, this approach uses rather considerable computer resources. Indeed, it is possible for a customer service center to receive several tens of thousands of calls per day, and systematically, upon the arrival of each call, searching for the identifier in a database listing all the calls received during the day can consume a great deal of system resources.

Our methods make it possible to overcome this. Indeed, we provide a method of deducing statistics relating to call intents and recalls only according to statistics relating to calls received, disconnected and abandoned, which make up the default data supplied by the ACD (Automatic Call Dispatcher).

We therefore provide methods of estimating call intents and recalls in a call center comprising:
(a) assessing N corresponding to the number of periods during which the recall assessments are performed;
(b) assessing αᵢ representing the proportion of disconnected calls that call back during the i^{th} period following disconnection;
(c) assessing βᵢ representing the proportion of abandoned calls that call back during the i^{th} period following abandonment;
(d) assessing the call status variables:
Dec(p) representing the number of calls disconnected during a period p;
   Abd(p) representing the number of calls abandoned during a period p;
   Reçus(p) representing the number of calls received during a period p;
(e) estimating the number of recalls, rappels(p), during said period p, with

$$rappels ( p ) = {\sum }_{i = 0}^{N} {α}_{i} \cdot dec ( p - i ) + {β}_{i} \cdot abd ( p - i ) ,$$

where p-i represents the period that precedes p of i periods; and
(f) assessing the number of call intents during a period p, intentions(p)=reçus(p)−rappels(p).

The coefficients αᵢ and βᵢ are preferably calculated by linear regression in at least one representative sample.

The estimation is advantageously performed without systematically recording the identifier of each call received.

The capacity of the call center is advantageously adapted according to the estimation.

This disclosure also relates to a system for estimating call intents and recalls in a call center comprising calculation equipment connected to equipment associated with the call-answering stations, characterized in that the calculation equipment comprises means for counting the number of disconnected calls Dec, the number of abandoned calls Abd, the number of received calls Reçus and calculation means for determining the coefficients αᵢ, βᵢ and N, as well as calculation means for determining the variables of the number of recalls and the number of call intents

$$rappels ( p ) = {\sum }_{i = 0}^{N} {α}_{i} \cdot dec ( p - i ) + {β}_{i} \cdot abd ( p - i )$$

and intentions(p)=reçus(p)−rappels(p),
where N corresponds to the number of periods during which the assessment of recalls takes place;

αᵢ represents a proportion of disconnected calls that call back during the i^{th} period following disconnection;

βᵢ represents a proportion of abandoned calls that call back during the i^{th} period following abandon; and

p-i represents a period that precedes p of i periods.

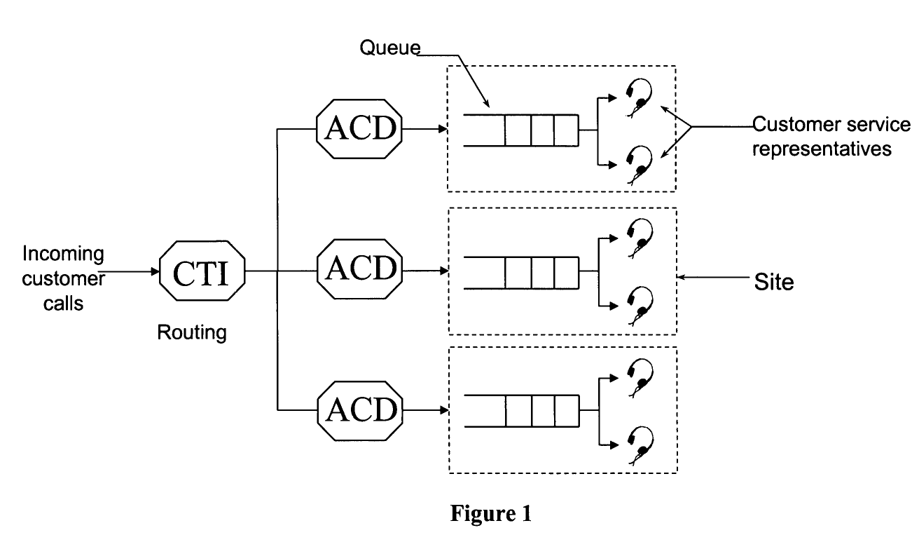

As shown in FIG. 1, customer calls arrive first at a CTI (Computer Telephony Integration). According to information supplied by the ACD (Automatic Call Dispatcher) of each site, a routing mechanism makes it possible to decide to which site a call should be routed upon its arrival. Once the call is routed and if no customer service representative is able to answer it immediately, it is placed on hold in a queue. The phenomena of abandon and disconnection therefore complicate the management of such a call center.

Indeed, as shown in FIG. 1, there is a customer who decides to call the call center: this is a first call intent (1). This call can have several possible outcomes.

First, it can be placed in a queue (2) and then answered by a customer service representative. This is an answered call.

If it were possible in terms of available resources, all first call intents would be answered calls. However, a customer generally has to wait a short while before being answered by a customer service representative. It is possible, therefore, that such customer will prematurely end the call: this is an abandoned call (3).

Finally, a customer might call when the number of persons in the queue has reached a set limit size for the queue. At this time, the customer is asked to call back later: this is a disconnected call (4). Among the customers that have abandoned the queue or been disconnected, a percentage abandons for good, as in (6); as for the other customers, they try to reach a customer service representative: this is called recall or call reiteration (7).

All the calls passed on to the customer centers, regardless of the nature of the call and its outcome, make up the received calls (8) (i.e. the total number of calls answered, abandoned or disconnected).

The ACDs (Automatic Call Dispatchers, which dispatch the calls to the customer service representatives) make it possible, among others, to supply statistics regarding the calls. In this way, the ACD reporting modules can, for example, supply information relating to the number of calls received or answered every half hour for the last two weeks.

Therefore, in a general fashion, it is possible by means of the ACD to assess the following parameters and variables for different periods:
αᵢ represents a proportion of disconnected calls that call back during the i^{th} period following disconnection,
βᵢ represents a proportion of abandoned calls that call back during the i^{th} period following abandonment,
   and N corresponds to the number of periods in which the recall assessments are conducted.

The different coefficients αᵢ and βᵢ characterize the behavior of the customer with regard to the call. These do not vary in real time and can be, for example, calculated using a linear regression method on a sample that is representative of the recall phenomenon during a “standard day” of the relevant call center.

In addition, the call status statistics are assessed in real time over a period p using the ACDs. The following is then obtained for the period:
Dec(p) representing the number of calls disconnected during a period p;
Abd(p) representing the number of calls abandoned during a period p; and
Reçus(p) representing the number of calls received during a period p.

The number of call intents during a period p is then obtained by:

$$rappels ( p ) = {\sum }_{i = 0}^{N} {α}_{i} \cdot dec ( p - i ) + {β}_{i} \cdot abd ( p - i ) ,$$

where p-i represents the period that precedes p of i periods.

The number of call intents during a period p is then obtained by:
intentions(p)=reçus(p)−rappels(p).

There are many foreseeable technical applications of this method of assessing the number of call intents. This makes it possible, first of all, to size call centers by adapting the number of sites or the number of customer service representatives. This sizing is then possible in overall terms as well as by periods.

Another application is to reconstruct call intent histories according to the histories of calls received, abandoned and disconnected. Another usage is to allow an assessment of the quality of service with regard to call intents (rather than with regard to calls received). We make it possible to perform this estimation in real time and to do so without mobilizing considerable computing resources.

This disclosure is described above by way of example. Those skilled in the art will be able to implement various alternative aspects without thereby departing from the scope of the appended claims.

1. A method of estimating call intents and recalls in a call center comprising:
(a) assessing N corresponding to a number of periods during which recall assessments are performed;
(b) assessing αᵢ representing a proportion of disconnected calls that call back during an i^{th} period following disconnection;
(c) assessing βᵢ representing a proportion of abandoned calls that call back during i^{th} period following abandonment;
(d) assessing call status variables:
Dec(p) representing the number of calls disconnected during a period p;
Abd(p) representing the number of calls abandoned during a period p;
Reçus(p) representing the number of calls received during period p;
(e) estimating the number of recalls, rappels(p), during the period p, with
$$rappels ( p ) = {\sum }_{i = 0}^{N} {α}_{i} \cdot dec ( p - i ) + {β}_{i} \cdot abd ( p - i ) ,$$
where p-i represents the period that precedes p of i periods; and
(f) assessing the number of call intents during a period p, intentions(p)=reçus(p)çrappels(p).

2. The method according to claim 1, wherein coefficients αᵢ and βᵢ are calculated by linear regression in at least one representative sample.

3. The method according to claim 1, wherein estimation is performed without systematically recording an identifier of each call received.

4. The method according to claim 1, wherein capacity of the call center is adapted according to the estimation.

5. A system for estimating call intents and recalls in a call center comprising calculation equipment connected to equipment associated with call-answering stations, wherein the calculation equipment comprises means for counting a number of disconnected calls Dec, a number of abandoned calls Abd, a number of received calls Reçus and calculation means for determining coefficients αᵢ, βᵢ and N, as well as calculation means for determining variables of the number of recalls and the number of call intents
$$rappels ( p ) = {\sum }_{i = 0}^{N} {α}_{i} \cdot dec ( p - i ) + {β}_{i} \cdot abd ( p - i )$$
and intentions(p)=reçus(p)−rappels(p), where N corresponds to a number of periods during which an assessment of recalls takes place;
αᵢ represents a proportion of disconnected calls that call back during an i^{th} period following disconnection;
βᵢ represents a proportion of abandoned calls that call back during an i^{th} period following abandonment; and
p-i represents a period that precedes p of i periods.

6. The system, according to claim 5, further comprising at least one Automatic Call Dispatcher (ACD).
